(19) United States
(12) Patent Application Publication
(10) Pub. No.: US 2019/0274348 A1
(43) Pub. Date: Sep. 12, 2019

(54) FOOD FORMING DEVICE AND FOOD FORMING EQUIPMENT

(71) Applicant: NICHIREI FOODS INC., Tokyo (JP)

(72) Inventors: Yoshito FUJIMORI, Chiba-shi (JP); Jiro KITAMURA, Chiba-shi (JP); Hirokazu CHUKYO, Chiba-shi (JP)

(73) Assignee: NICHIREI FOODS INC., Tokyo (JP)

(21) Appl. No.: 16/349,112

(22) PCT Filed: Nov. 9, 2017
(86) PCT No.: PCT/JP2017/040483

§ 371 Date: May 10, 2019

(30) Foreign Application Priority Data
Nov. 11, 2016 (JP) 2016-221018

(51) Int. Cl. A23P 30/10; A22C 7/00

(52) U.S. Cl. CPC A23P 30/10; A22C 7/0084

(57) ABSTRACT

A food forming device includes a mold plate and pushers. The mold plate includes n first forming holes and n second forming holes provided alternately in a circumferential direction of the mold plate, n being an integer of two or more. The mold plate intermittently rotates to a first rotation position and to a second rotation position. In the first rotation position, the first forming holes are respectively connected with the discharge holes while lower openings of the second forming holes are obstructed by the bottom plate. In the second rotation position, the second forming holes are respectively connected with the discharge holes while lower openings of the first forming holes are obstructed by the bottom plate. The pushers push out the foodstuffs from the first forming holes or the second forming holes to discharge the foodstuffs as formed food products every time the mold plate intermittently rotates.

### TECHNICAL FIELD

The present invention relates to a food forming device and a food forming system.

### BACKGROUND ART

A food forming device is known that obtains a formed food product which is a foodstuff having been formed into a predetermined shape, by injecting a foodstuff which has been prepared for a food such as hamburger in a forming hole having a predetermined form, and extracting the foodstuff from the forming hole. In addition, a food forming device is also known from Patent Literature 1, which is configured so as to be capable of producing many formed food products in a short period of time, by simultaneously extracting formed food products from a plurality of forming holes, respectively.

The food forming device described in Patent Literature 1 includes a frame member that is provided with a plurality of forming holes which penetrate vertically, and a bottom plate or the like, which is provided with a plurality of discharge holes that penetrates vertically and on which the frame member is mounted; and discharges a plurality of formed food products onto a conveying belt at the same time. In the frame member, a plurality of forming holes are provided in two rows; and in the bottom plate, a plurality of discharge holes are provided in two rows, and also a flat portion is provided between each row of the discharge holes. The frame member is configured to be slidable along a direction in which the formed food product is conveyed (direction in which conveying belt moves); and alternately moves to a first position at which forming holes in one row are connected with discharge holes in the one row, respectively, and also a lower opening in each forming hole in the other row is obstructed by a flat portion, and a second position at which forming holes in the other row are connected with discharge holes in the other row, respectively, and also a lower opening of each forming hole in the one row is obstructed by the flat portion.

In the above described food forming device, the frame member moves from the second position to the first position, then the foodstuff is injected in the forming holes of the one row, of which the lower openings are obstructed by the flat portion, respectively, and the pushers push out the foodstuffs from the forming holes in the other row, which are connected with discharge holes, respectively. The food forming device pushes out the foodstuff, then moves the frame member to the second position from the first position, injects the foodstuff in each of the forming holes in the one row, which have become empty after the foodstuffs have been discharged in the first position, and of which the lower openings are obstructed by the flat portion, and pushes out the foodstuffs that have been injected in the first position, from the forming holes in the other row, which have been connected with discharge holes, by the pushers, respectively. After this, the frame member moves from the second position to the first position. In this way, a plurality of formed food products is sequentially discharged onto the conveying belt in a state of being arranged in a row.

On the other hand, various food forming devices are known that rotate a rotating plate which has a plurality of forming holes formed on the circumference, or a drum which has a plurality of forming holes formed on the circumferential surface, and sequentially perform operations from the injection of the foodstuff into the forming holes to the discharge while the rotating plate or the drum rotates one loop (for example, Patent Literatures 2 to 4, and Non-Patent Literature 1).

### CITATION LIST

### Patent Literature

Patent Literature 1: Japanese Patent No. 4163163
Patent Literature 2: Japanese Patent Laid-Open No. 61-128873
Patent Literature 3: Japanese Patent Laid-Open No. 2007-319149
Patent Literature 4: Japanese Patent No. 4938702

### Non-Patent Literature

Non-Patent Literature 1: Yamanaka Shokuhinki Seisakusho Co., Ltd. [online], [Searched on Oct. 21, 2016], Internet <URL: http://yamanaka-syokuhinki.co.jp/Machines.html>

### SUMMARY OF INVENTION

### Technical Problem

As described above, as for the food forming device of Patent Literature 1, the frame member reciprocates between the first position and the second position along the direction in which the formed food product is conveyed, but a distance for the frame member to reciprocate between the first position and the second position is large, and the movement time period becomes long. Because of this, there has been a problem that the number of formed food products is small which are obtained per unit time. In addition, also in the food forming devices of Patent Literatures 2 to 4 and Non-Patent Literature 1, there has been a problem that the number of the formed food products is small which are obtained per unit time.

The present invention has been made in view of the foregoing, and an object of the invention is to provide a food forming device and a food forming system that make it possible to increase the number of formed food products per unit time.

### Solution to Problem

A food forming device of the present invention includes: a bottom plate including n (n is 2 or more) discharge holes provided on a circumference; a mold plate that is rotatable on the bottom plate and includes n first forming holes and n second forming holes provided alternately in a circumferential direction of the mold plate, the mold plate being configured to intermittently rotate to a first rotation position and to a second rotation position, wherein: in the first rotation position, the first forming holes are respectively connected with the discharge holes while lower openings of the second forming holes are obstructed by the bottom plate; and in the second rotation position, the second forming holes are respectively connected with the discharge holes while lower openings of the first forming holes are obstructed by the bottom plate; a plurality of filling openings that is: deviated from the discharge holes in the circumferential direction; respectively configured to be connected to upper openings of the second forming holes in the first rotation position; respectively configured to be connected to upper openings of the first forming holes in the second rotation position; and configured to inject foodstuffs into the first forming holes or the second forming holes connected to the plurality of filling openings; and a plurality of pushers that is vertically movable and is respectively provided above the discharge holes, and configured to push out the foodstuffs from the first forming holes or the second forming holes to discharge the foodstuffs as formed food products from the discharge holes every time the mold plate intermittently rotates.

A food forming system of the present invention includes the food forming device, and a conveying belt arranged below the bottom plate and configured to intermittently or continuously move the formed food products.

### Advantageous Effects of Invention

The food forming device of the present invention is configured to rotate the mold plate that is provided with the plurality of first forming holes and the plurality of second forming holes, accordingly can switch the mold plate between the first rotation position at which the foodstuffs are injected into the second forming holes and the formed food products are discharged from the first forming holes and the second rotation position at which the foodstuffs are injected into the first forming holes and the formed food products are discharged from the second forming holes, in a short time period, and accordingly can increase the number of formed food products which are obtained per unit time.

### BRIEF DESCRIPTION OF DRAWINGS

FIG. 1 is a perspective view of a food forming system of a first embodiment.

FIG. 2 is an exploded perspective view of a configuration of a main body part of the food forming device.

FIG. 3 is a cross-sectional view immediately after a mold plate rotates to a first rotation position.

FIG. 4 is a cross-sectional view after a formed food product is discharged from the mold plate in the first rotation position.

FIG. 5 is a cross-sectional view of a lid member being attached to an upper part of a pusher port.

FIG. 6 is a perspective view of a food forming system of a second embodiment.

FIG. 7 is an explanatory view schematically illustrating an example of a layout of a food forming device according to a second embodiment.

FIG. 8 is an exploded perspective view of a leakage prevention member arranged in a pusher port of a third embodiment.

FIG. 9 is a cross-sectional views of a configuration of a main body part of a food forming device according to a fourth embodiment.

### DESCRIPTION OF EMBODIMENTS

### First Embodiment

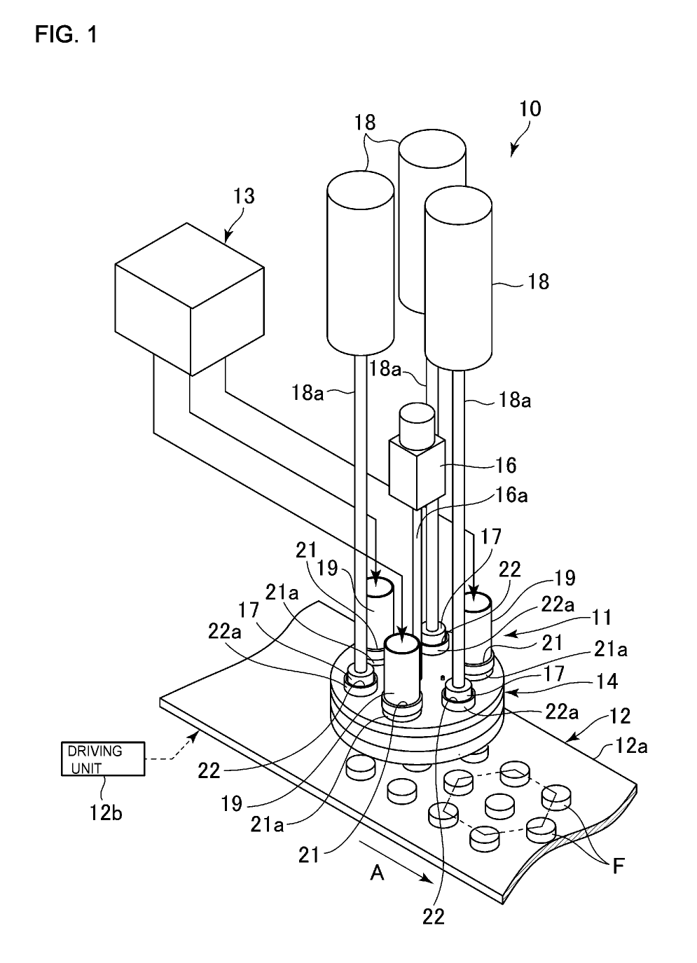

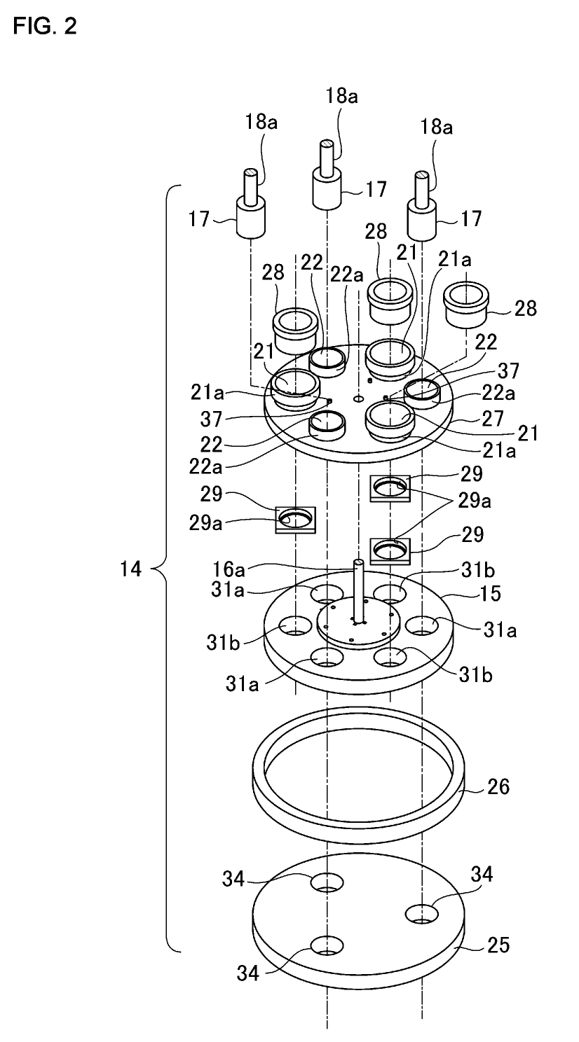

In FIG. 1, a food forming system 10 includes a food forming device (hereinafter simply referred to as “forming device”) 11, a conveying system 12, and a foodstuff supply unit 13. The forming device 11 includes a main body part 14, a motor 16 which rotates a mold plate 15 (see FIG. 2) in the main body part 14, an actuator 18 which vertically moves a pusher 17, and the like. As the motor 16, for example, a stepping motor, a servomotor, or the like is used, which thereby accurately controls a rotation position of the mold plate 15. The conveying system 12 includes a conveying belt 12a and a driving unit 12b, and conveys a formed food product F which has been discharged from the forming device 11. The conveying belt 12a is driven by the driving unit 12b to continuously move at a predetermined speed, and conveys the formed food product F in the conveying direction indicated by the arrow A. A speed of the conveying belt 12a is determined so that the formed food products F do not overlap one another on the conveying belt 12a. The forming device 11 is fixed above the conveying belt 12a by a not-shown supporting member.

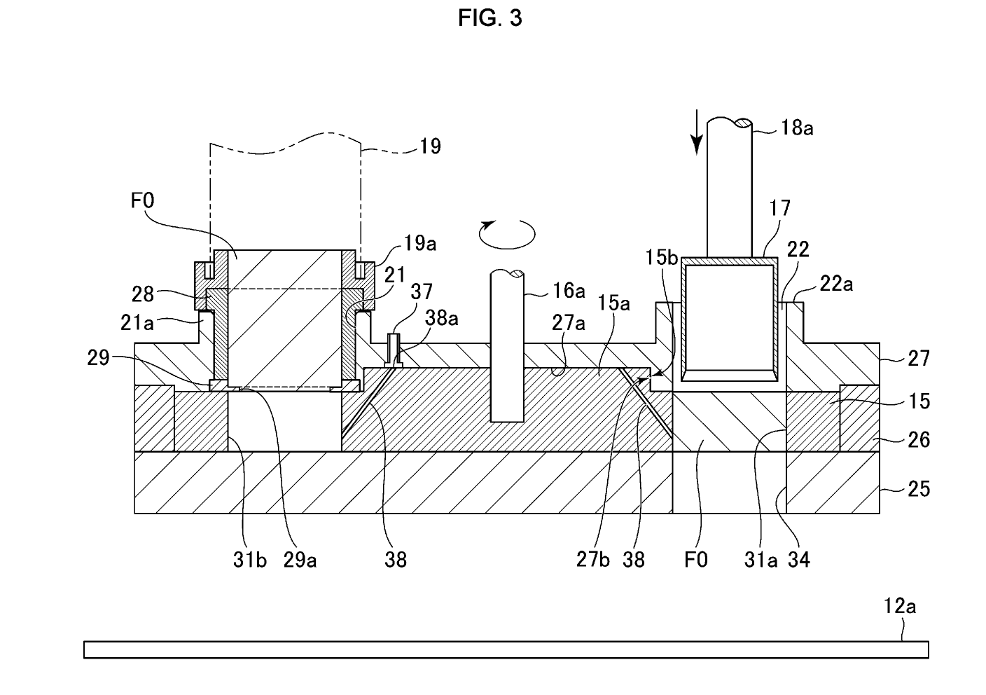

The foodstuff supply unit 13 is connected to three input ports 21 which are provided on the upper portion of the main body part 14, through pipes 19, respectively. A foodstuff F0 (see FIG. 3) such as minced meat and/or chopped vegetables is supplied from this foodstuff supply unit 13 to the inside of the main body part 14 through a pipe 19 and an input port 21, by a predetermined pressure. As will be described later, the foodstuff F0 which is supplied through the input port 21 is formed in the inside of the main body part 14. The pushers 17 are arranged in the three pusher ports 22, respectively, which are provided on the upper portion of the main body part 14. The pushers 17 are connected with shafts 18a of the actuators 18, respectively, and are moved up and down by the actuators 18. The actuator 18 is not limited in particular, and for example, an air cylinder, a linear motor or the like can be used. In addition, it is acceptable to compose the actuator 18 by a motor and a link mechanism, for example, a link mechanism that has a lever which is connected to the rotating shaft of the motor and a connecting plate of which one end is rotatably connected to the lever and the other end is rotatably connected to the shaft 18a, and to move the pusher 17 up and down by rotation of the motor in one direction or by repetition of normal rotation and reverse rotation.

The foodstuff F0 which has been formed in the inside of the main body part 14 is pushed out downward by the pusher 17, and is discharged as a formed food product F onto the conveying belt 12a. In this embodiment, the three pushers 17 move down at the same time, and thereby three formed food products F are simultaneously discharged onto the conveying belt 12a. The conveying belt 12a may be intermittently moved in synchronization with the discharge of the formed food product F. In this case, the movement length of the conveying belt 12a per one time may be determined so that the formed food products F which are sequentially discharged do not overlap one another on the conveying belt 12a.

As shown in FIG. 2, the main body part 14 of the forming device 11 includes the mold plate 15, a bottom plate 25, a spacer 26, an upper plate 27, an inner cylinder 28, a blade part 29, and the like. All of the mold plate 15, the bottom plate 25 and the upper plate 27 have disk shapes, and the spacer 26 has a ring shape; and these components are assembled coaxially to each other. Among the components, the bottom plate 25, the spacer 26, the upper plate 27, the inner cylinder 28 and the blade part 29 are made of metal, and the mold plate 15 is made of resin. The mold plate 15 may be also made of metal.

The mold plate 15 is arranged on the bottom plate 25 so as to be rotatable with the center thereof at the rotation center of the bottom plate 25. The spacer 26 is arranged around the outer circumference of the mold plate 15. The upper plate 27 is arranged above the mold plate 15, and the distance between itself and the bottom plate 25 are kept constant by the spacer 26. Such a spacer is used as the spacer 26 that the height corresponds to the thickness of the mold plate 15, and when the mold plate 15 is exchanged to a mold plate having a different thickness, the spacer 26 is also exchanged to a spacer having a thickness which corresponds to the thickness of the mold plate 15 to be exchanged. The spacer 26 may be integrated with the upper plate 27.

The upper plate 27 has a function of pressing the mold plate 15 toward the lower side. In addition, the spacer 26 and the upper plate 27 arranged as described above suppress the leakage of the foodstuff F0 from the main body part 14 to the outside. Specifically, the spacer 26 suppresses the leakage of the foodstuff F0 which has leaked to the upper surface and the lower surface of the mold plate 15, toward a radial direction of the mold plate 15, and the upper plate 27 suppresses the leakage toward the upper portion of the main body part 14. The spacer 26 is not limited to the above described shape. The spacer 26 may have any shape as long as the spacer is arranged around the outer circumference of the mold plate 15 so as to surround the mold plate 15, and there may be a gap between the spacer 26 and the mold plate 15. For example, the spacer 26 may be a plate member which has such a hole formed therein that the mold plate 15 is arranged therein, or may have such a hole therein as to be a polygonal (for example, hexagonal) shape and circumscribe the mold plate 15, as a hole in which the mold plate 15 is arranged.

In the mold plate 15, three (=n) first forming holes 31a and three second forming holes 31b are provided for forming the foodstuff F0 into a predetermined shape. The first forming holes 31a and the second forming holes 31b are alternately provided along the circumferential direction, and the interval between the first forming hole 31a and the second forming hole 31b is configured to be 60°. For information, the first forming hole 31a and the second forming hole 31b are classified for the sake of convenience by the timing at which the foodstuff F0 is injected and the timing at which the foodstuff F0 is discharged, and are not particularly distinguished according to the shape or the like. In the following description, when the first forming hole 31a and the second forming hole 31b are not distinguished from each other, each of the holes are collectively referred to as a forming hole 31.

Each of the forming holes 31 is a hole which penetrates the mold plate 15 in the thickness direction. Into the inside of the forming hole 31, the foodstuff F0 is injected from the input port 21, and the foodstuff F0 in this forming hole 31 is formed by being separated from the foodstuff F0 in the input port 21 along with the rotation of the mold plate 15.

The above described mold plate 15 is exchangeable, and the mold plate is used in which a forming hole 31 is formed according to the shape of the formed food product F. In addition, as described above, a mold plate 15 having different thickness can be used, and the thickness of the formed food product F can be changed, by exchanging the spacer 26 together with the mold plate 15.

As for the bottom plate 25, the upper surface is formed to be flat, and also 3 (=n) discharge holes 34 are formed. The upper surface of the bottom plate 25 tightly obstructs the lower opening of the forming hole 31, and thereby functions as a part of a die for forming. The discharge hole 34 is a hole for discharging the formed foodstuff F0 in the forming hole 31 from the bottom part of the main body part 14, and penetrates in the thickness direction of the bottom plate 25. In order to facilitate the discharge of the foodstuff F0, these discharge holes 34 are tapered so that the inner diameters slightly increase toward the lower side. In this example, the discharge hole 34 is configured to have a tapered shape, but the discharge hole 34 may have such a size and a shape as to be capable of discharging the formed foodstuff F0 therefrom, and for example, may have a shape which is larger than the forming hole 31 and has a constant inner diameter in the axis center direction.

The above described discharge holes 34 are formed at intervals of 120° along the circumferential direction, and the positions of the discharge holes 34 in the radial direction from the rotation center of the mold plate 15 coincide with the positions of the forming holes 31, respectively. Thereby, the forming holes 31 can be connected with the discharge holes 34 by the rotation of the mold plate 15, and the foodstuff F0 in the forming hole 31 can be discharged from the discharge holes 34. The discharge holes 34 are deviated by 60° in the circumferential direction from the position right under the input port 21, and are arranged right below the pusher port 22.

The mold plate 15 on the bottom plate 25 is engaged with a rotating shaft 16a of the motor 16, is intermittently rotated by 60° by the motor 16, and alternately rotate to the first rotation position and to the second rotation position. The first rotation position is a position at which the first forming hole 31a is connected with the discharge hole 34 and the lower opening of the second forming hole 31b is obstructed by the upper surface of the bottom plate 25, and the second rotation position is a position at which the second forming hole 31b is connected with the discharge hole 34 and the lower opening of the first forming hole 31a is obstructed by the upper surface of the bottom plate 25. In addition, at the first rotation position, the second forming hole 31b is positioned right below the input port 21, and at the second rotation position, the first forming hole 31a is positioned right below the input port 21. In this example, the mold plate 15 is intermittently rotated in one direction at intervals of 60° to be alternately set at the first rotation position and the second rotation position. For information, the rotation direction may be switched so that the mold plate 15 is rotated from the second rotation position by 60° in one direction, for example, in a clockwise direction, to the first rotation position, and is rotated from the first rotation position by 60° in a counterclockwise direction, to the second rotation position.

On the upper plate 27, three input ports 21 and three pusher ports 22 are provided. Both the input port 21 and the pusher port 22 are formed as hollow interior spaces of cylindrical sleeves 21a and 22a, and are connected to the inside of the main body part 14. The input ports 21 and the pusher ports 22 are alternately arranged at intervals of 60° along the circumferential direction, and are provided so that the pusher ports 22 is above the discharge holes 34, respectively. In addition, the upper plate 27, is provided with a pressure-reducing hole 37 for each of the input ports 21.

The inner cylinder 28 is fixed in each of the input ports 21. In addition, the pipes 19 are fixed to the upper ends of the input ports 21 (sleeves 21a) via fitting members 19a (see FIG. 3), respectively. At the lower end of the inner cylinder 28, a blade part 29 is attached. The blade part 29 has such a structure that a cutting blade 29a is provided along the inner circumference of a circular hole which is formed in the center of the plate-like member. The foodstuff F0 which is supplied from the pipe 19 passes through the inner cylinder 28, and is injected into the forming hole 31 from the opening (hole of blade part 29) at the lower end of the inner cylinder 28, which functions as a filling opening in the lower part of the input port 21. The blade part 29 is arranged in a concave portion which is provided in the lower side of the upper plate 27, and is in a state of being in close contact with the upper surface of the mold plate 15. For information, the inner cylinder 28 may be omitted, and the foodstuff F0 may be injected into the forming hole 31 while being directly passed through the input port 21. In addition, the shape of the hole of the blade part 29 and the shape of the cutting blade 29a are not limited to the above described shapes, but can be appropriately determined according to the type of the foodstuff F0, the shape of the forming hole 31, and the like. Furthermore, instead of the blade part 29 being arranged, the inner cylinder 28 may be used which has the cutting blade 29a integrally formed at the lower end.

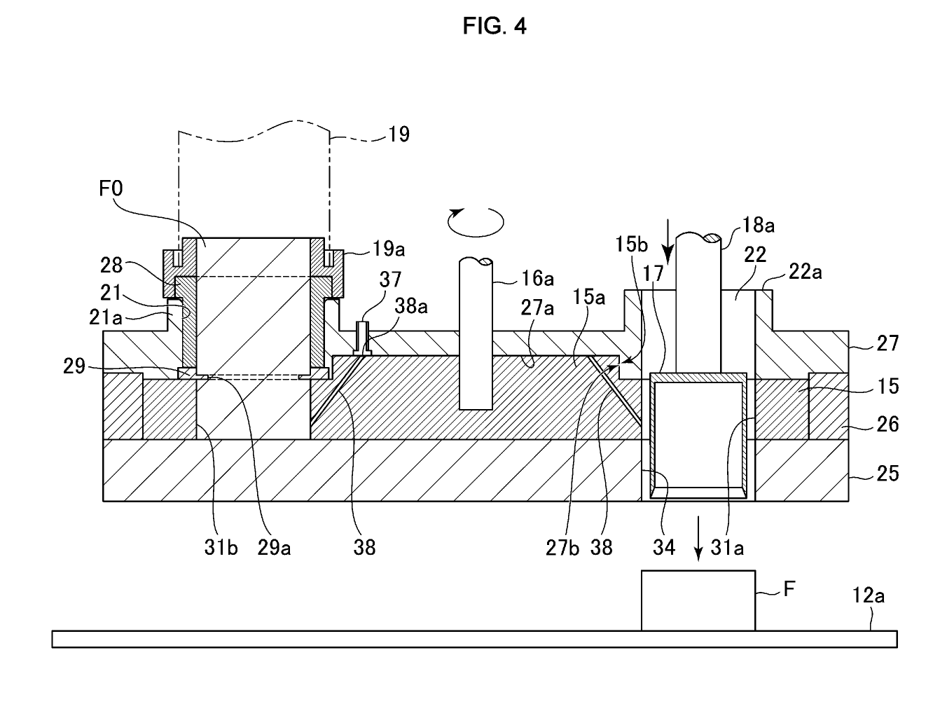

As shown in FIG. 3, each of the pushers 17 moves between an evacuating position to which the pusher evacuates from the forming hole 31 and at which the pusher is accommodated in the pusher port 22, and an extruding position at which the pusher moves down from the evacuating position to the discharge hole 34 and pushes out the foodstuff F0 from the forming hole 31, as shown in FIG. 4. In this example, the pusher 17 has a cylindrical shape of which the upper portion is obstructed. The shape of the lower end of the pusher 17 can be selected according to the type of the foodstuff F0, and may be, for example, a straight shape, a saw-toothed shape or the like, and may also be a shape in which the lower end of the pusher 17 has an angle with respect to the horizontal plane. In addition, the shape of the pusher 17 is not limited to the above described shapes, and for example, the pusher 17 may have a columnar shape and may push the foodstuff F0 in the forming hole 31 by its lower surface. Furthermore, the foodstuff F0 may push out from the inside of the forming hole 31 by an air pressure.

The pusher 17 is configured to be attachable to and detachable from the shaft 18a, and can be exchanged with another one which corresponds to the type of the foodstuff F0 and the shape and size of the forming hole 31. The pusher 17 is used which has such a shape and size in a horizontal cross section as to be capable of entering the forming hole 31. It is also preferable to determine the shape and size of the horizontal cross section of the pusher 17 with respect to the shape and size of the horizontal cross section of the forming hole 31, according to the type and degree of binding of the foodstuff F0.

For example, in the case of the foodstuff F0 of which the binding is weak, it is preferable to make the shapes and sizes of the horizontal cross sections of the pusher 17 and the forming hole 31 substantially coincide with each other so that a gap between the outer circumferential surface of the pusher 17 and the inner circumferential surface of the forming hole 31 is minimized as much as possible. Thereby, it becomes possible to prevent the foodstuff F0 sent from the forming hole 31 from entering a space between the outer circumferential surface of the pusher 17 and the inner circumferential surface of the sleeve 22a, to prevent the collapse of the foodstuff F0 at the time of extrusion, and also to suppress the leakage of the foodstuff F0 toward the outside of the main body part 14 through the pusher port 22. On the other hand, in the case of the foodstuff F0 having strong binding, the shapes and sizes of the horizontal cross sections of the pusher 17 and the forming hole 31 may not coincide with each other, and a gap may be formed between the outer circumferential surface of the pusher 17 and the inner circumferential surface of the forming hole 31. This is because even if the gap is formed between the outer circumferential surface of the pusher 17 and the inner circumferential surface of the forming hole 31, the binding is strong, accordingly the foodstuff F0 at the time of extrusion is not collapsed, and the foodstuff F0 does not enter the gap.

FIG. 3 is a state immediately after the mold plate 15 has rotated to the first rotation position. As shown in FIG. 3, at the first rotation position, the pusher ports 22 and the discharge holes 34 are connected with the first forming holes 31a, respectively, and also the upper openings of the second forming holes 31b are connected to the filling openings, respectively, in other words, the second forming holes 31b are connected with inner cylinders 28 which are inserted in the input ports 21, respectively; and the lower openings of the second forming holes 31b are obstructed by the upper surface of the bottom plate 25. Immediately after the mold plate 15 has rotated to the first rotation position, the foodstuff F0 which has been supplied at the immediately preceding second rotation position is in a state of being injected in the first forming hole 31a, and the second forming hole 31b is in an empty state.

As shown in FIG. 4, after the mold plate 15 has rotated to the first rotation position, the foodstuff F0 which is supplied from the inner cylinder 28 is injected into each of the second forming holes 31b. In addition, each of the pushers 17 moves down from the evacuating position to the extruding position; and thereby the foodstuff F0 which has been injected in each of the first forming holes 31a is pushed out from the first forming hole 31a, passes through the discharge hole 34, and is discharged onto the conveying belt 12a, as the formed food product F.

When the mold plate 15 is rotated at the second rotation position, the aspect is the same as the above description except that the first forming hole 31a and the second forming hole 31b opposite each other, and accordingly the illustration and detailed explanation thereof will be omitted.

As described above, the forming hole 31 to which the foodstuff F0 is injected and the forming hole 31 from which the formed food product F is discharged are switched by the rotation of the mold plate 15, and accordingly can be switched in a short time as compared with a structure of sliding the frame member as in the food forming device of Patent Literature 1. Accordingly, it becomes possible to increase the number of formed food products which are obtained per unit time.

In addition, in the food forming device of Patent Literature 1, the frame member reciprocates along the conveying direction. Because of this, a distance between the row of the formed food products that have been discharged at the position at which the frame member has been moved in the same direction as the conveying direction and the row of the formed food products that have been discharged after this at the position at which the frame member has been moved in a direction opposite to the conveying direction, and a distance between the row of the formed food products that have been discharged at the position at which the frame member has been moved in the direction opposite to the conveying direction and the row of the formed food products that have been discharged at the position at which the frame member has been moved after this in the same direction as the conveying direction are determined according to a time interval of the discharge of the formed food products and a conveying speed thereof. Then, the conveying speed at which the distance between these rows (distance between formed food products in conveying direction) becomes equal is uniquely determined with respect to the time interval of the discharge of the formed food products at each position of the frame member, and accordingly a degree of freedom of setting of a production line is restricted which includes the food forming device. In other words, in the case where the conveying speed has been set without considering the time interval of the discharge of the formed food products at each position of the frame member, the distances between the formed food products in the conveying direction have wide one and narrow one. For example, there is a case where the distance between the formed food products in the conveying direction becomes too narrow, which may cause troubles in processes in subsequent steps. As a result, the structure in which the frame member reciprocates in the conveying direction causes a restriction in the improvement of the production efficiency. In contrast to this, the forming device 11 of the embodiment does not cause such restriction, and can improve the production efficiency.

Furthermore, the formed food products F are discharged onto the conveying belt 12a with the same layout as that of the discharge hole 34, by one time of downward movement of each of the pushers 17, accordingly it is possible to further increase the number of the formed food products F per unit area on the conveying belt 12a, by the pushers 17 pushing out the formed food products F in a cycle corresponding to the speed of the conveying belt 12a and the arrangement of the discharge holes 34. In particular, when the number of the discharge holes 34 is three, the effect becomes remarkable.

In the case where the three discharge holes 34 are provided as described above, three formed food products F are discharged so as to become each vertex of an equilateral triangle corresponding to the arrangement of the discharge holes 34. In this case, the main body part 14 is provided so that any one side (hereinafter referred to as reference side) of the equilateral triangle whose vertices are defined by the three discharge holes 34 is orthogonal to the moving direction of the conveying belt 12a, and the formed food product F shall be discharged every time the conveying belt 12a moves by a length of ⅔ of the height of the equilateral triangle of which the reference side is arranged so as to form the bottom side. By this method, as shown by the two-dot chain line in FIG. 1, each of the formed food products F is discharged in such an arranged state as to be any one of each vertex of a regular hexagon of which one side has a length of ⅔ of the height of an equilateral triangle whose vertices are defined by the three discharge holes 34, and its center of gravity; and it is possible to maximize the number of the formed food products F per unit area while making the adjacent formed food products F equidistant.

As shown in FIG. 3 and FIG. 4, the center portion of the mold plate 15 is structured to be a convex portion 15a that becomes higher than a portion at which the forming hole 31 is provided, and a concave portion 27a is formed in the center portion of the lower surface of the upper plate 27. By the convex portion 15a being thus formed, a circumferential step 15b is provided on the mold plate 15, and by the concave portion 27a being formed, a circumferential step 27b is provided in the upper plate 27. In a state in which the upper plate 27 is assembled on the mold plate 15, the convex portion 15a enters into the concave portion 27a. The inner diameter of the concave portion 27a is formed so as to be equal to or slightly larger than the outer diameter of the convex portion 15a. The mold plate 15 rotates in such a state that the step 15b and the step 27b of the upper plate 27 are engaged with each other. Thereby, the foodstuff F0 which has leaked from the boundary between the blade part 29 and the mold plate 15 is controlled so as not to spread toward the center of the mold plate 15, and the foodstuff F0 is controlled so as not to leak to the outside, from the hole which is provided in the upper plate 27, a gap formed between the upper plate 27 and the other member, and the like.

It is acceptable to provide a concave portion on the upper surface of the mold plate 15, and to fit a convex portion which has been provided on the lower surface of the upper plate 27, into this concave portion. In addition, it is also acceptable to fit a circumferential projection which has been provided as a circumferential convex portion in any one of the upper surface of the mold plate 15 and the lower surface of the upper plate 27, into a circumferential groove which has been provided in the other one as a circumferential concave portion. Thereby, the mold plate 15 may be configured to rotate in such a state that the steps which the grooves and the projections form respectively are engaged with each other. The space between the upper plate 27 and the rotating shaft 16a is closely obstructed so that the foodstuff F0 does not leak out onto the upper surface of the main body part 14. It is acceptable to arrange a seal member between the upper plate 27 and the rotating shaft 16a.

In the mold plate 15, an air vent hole 38 which communicates with the forming hole 31 is provided for each of the forming holes 31. One end of the air vent hole 38 is exposed to the upper surface of the central portion of the mold plate 15, as an opening 38a, and the other end is opened to the inside of the forming hole 31. The air vent hole 38 functions as a hole for removing air from the inside of the forming hole 31 therethrough when the foodstuff F0 is injected.

When the mold plate 15 exists in the first or second rotation position, the opening 38a of the air vent hole 38 that communicates with the forming hole 31 which is connected with the inner cylinder 28 is in a state of being linked to the pressure-reducing hole 37 which is provided in the upper plate 27. The pressure-reducing hole 37 is linked to pressure-reducing equipment (not shown). Thereby, the pressure-reducing equipment removes air from the forming hole 31 through the pressure-reducing hole 37 and the air vent hole 38 to facilitate the injection of the foodstuff F0 into the forming hole 31, and also prevents a non-charged region of the foodstuff F0 from being formed in the forming hole 31. The opening position of the air vent hole 38 in the forming hole 31 is preferably a position as close as possible to the bottom of the forming hole 31.

In this example, air is removed from the forming hole 31 through the air vent hole 38 by the pressure-reducing equipment, but it is also acceptable that one end of the air vent hole 38 is configured to open when the foodstuff F0 has been injected, and the air in the forming hole 31 passes through the air vent hole 38 to the outside, as the foodstuff F0 is injected into the inside of the forming hole 31.

Next, the operation of the above described configuration will be described. The foodstuff supply unit 13 continuously applies a predetermined pressure to the foodstuff F0 in the pipe 19, in order to supply the foodstuff F0 to the inner cylinder 28 through the pipe 19. When the mold plate 15 is rotated by the motor 16, for example, to the first rotation position from the second rotation position, as shown in FIG. 3, the lower openings of the respective second forming holes 31b becomes a state of being obstructed by the upper surface of the bottom plate 25, and also the second forming holes 31b are connected with the inner cylinders 28 via the blade parts 29, respectively. Thereby, the foodstuffs F0 sent from the inner cylinders 28 are pushed out into the inside of the second forming holes 31b, respectively, and as shown in FIG. 4, the second forming holes 31b are filled with the foodstuffs F0. At this time, air in the second forming holes 31b is removed through the air vent holes 38 and the pressure-reducing holes 37, respectively, and accordingly the foodstuffs F0 are injected so as to fill the respective second forming holes 31b.

On the other hand, by the rotation of the mold plate 15 to the first rotation position, as shown in FIG. 3, the pusher ports 22 and the discharge holes 34 are connected with the first forming holes 31a, respectively. Then, while the foodstuffs F0 are injected into the second forming holes 31b, respectively, as described above, actuators 18 simultaneously move down the pushers 17 from the evacuating positions to the extruding positions, respectively. By the movement of the pushers 17 to the extruding positions, as shown in FIG. 4, the foodstuffs F0 which are injected in the respective first forming holes 31a are pushed out downward by the pushers 17 and discharged from the discharge holes 34, respectively. Thereby, three formed food products F are simultaneously discharged onto the conveying belt 12a in a form of corresponding to the three first forming holes 31a. Each of the pushers 17 moves up from the extruding position and returns to the evacuating position.

After the injection of the foodstuff F0 into the second forming hole 31b has been completed and the pusher 17 has returned from the extruding position to the evacuating position, the motor 16 rotates the mold plate 15 from the first rotation position to the second rotation position. By this rotation, the lower openings of the first forming holes 31a of which the inside has become empty are obstructed by the upper surface of the bottom plate 25, respectively, and also the first forming holes 31a are connected with the inner cylinders 28 through the blade parts 29, respectively. Then, the foodstuffs F0 sent from the inner cylinders 28 are pushed out into the first forming holes 31a, respectively, and the foodstuffs F0 are injected into the first forming holes 31a, respectively. At this time, air in the first forming holes 31a is removed through the air vent holes 38 and the pressure-reducing holes 37 which communicate with the first forming holes 31a, respectively, and accordingly the foodstuffs F0 are injected so as to fill the respective first forming holes 31a.

On the other hand, in the second forming holes 31b into which the foodstuffs F0 have been injected at the first rotation position, when the mold plate 15 starts rotating to the second rotation position, the foodstuffs F0 are sheared by the cutting blades 29a of the blade parts 29, respectively, and the foodstuffs F0 in the second forming holes 31b are separated from the foodstuffs F0 in the inner cylinders 28, respectively. Then, when the mold plate 15 reaches the second rotation position, the pusher ports 22 and the discharge holes 34 are connected with the second forming holes 31b in which the foodstuffs F0 are injected, respectively. After this, the pushers 17 are moved down from the evacuating positions to the extruding positions at the same time by the actuators 18, respectively.

Thereby, the foodstuffs F0 which are injected in the second forming holes 31b are pushed out downward by the pushers 17, respectively, and are discharged through the discharge holes 34, respectively. This timing is timing at which the conveying belt 12a has moved by a length of ⅔ of the height of the equilateral triangle whose vertices are defined by the three discharge holes 34, from the time when the formed food product F has been discharged in advance from the first forming hole 31a.

As a result, the three formed food products F are simultaneously discharged onto the conveying belt 12a. The conveying belt 12a moves at a predetermined speed, and accordingly the three formed food products F which have been discharged from the second forming holes 31b do not overlap with the three formed food products F which have been previously discharged from the first forming holes 31a.

After the injection of the foodstuff F0 into the first forming hole 31a has been completed and the pusher 17 has returned from the extruding position to the evacuating position, the mold plate 15 rotates from the second rotation position to the first rotation position. By this rotation, the lower openings of the second forming holes 31b of which the insides have become empty are obstructed by the upper surface of the bottom plate 25, respectively; and also, the second forming holes 31b are connected with the inner cylinders 28 through the blade parts 29, and the foodstuffs F0 are injected thereinto, respectively. In addition, by the rotation of the mold plate 15, the foodstuffs F0 are sheared by the cutting blades 29a, and the foodstuffs F0 in the first forming holes 31a are separated from the foodstuffs F0 in the inner cylinders 28, respectively. Then, when the mold plate 15 reaches the first rotation position, the pusher ports 22 and the discharge holes 34 are connected with the first forming holes 31a in which the foodstuffs F0 are injected, respectively. Then, the formed food products F are discharged from the respective first forming holes 31a.

After this, by a similar procedure, every time the mold plate 15 rotates from the first rotation position to the second rotation position, and every time the mold plate 15 rotates from the second rotation position to the first rotation position, the foodstuff F0 is injected into each of the three forming holes 31, and the formed food product F is discharged from each of the other different forming holes 31.

As described above, the mold plate 15 is rotated to the first rotation position and the second rotation position by the rotation thereof, and is switched to the first rotation position and the second rotation position in a short time of period; the formed food products F are discharged and the foodstuffs F0 are injected, respectively, at each of the rotation position; and accordingly more formed food products F are obtained per unit time.

In addition, on the conveying belt 12a, the number of the formed food products F per unit area is sufficiently large, and becomes maximal in this example. Accordingly, the number of processed pieces per unit time also increases in the case, for example, where a post-process such as heating treatment is carried out while the conveying belt 12a conveys the formed food product F.

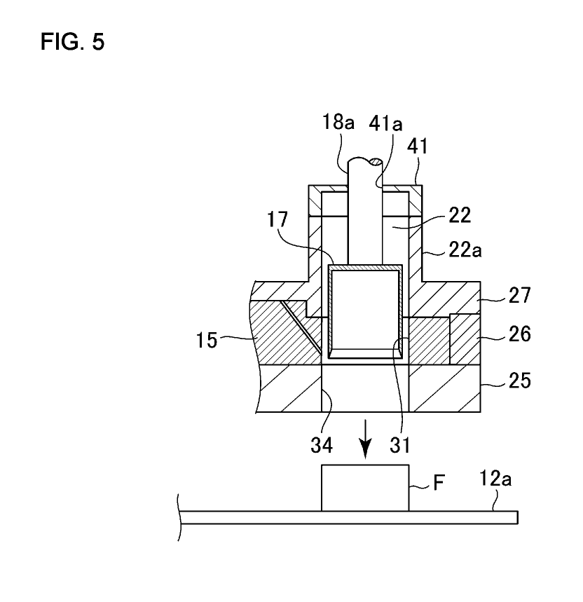

In the above described example, the upper opening of the pusher port 22 is exposed, but as shown in FIG. 5, the upper end portion of the pusher port 22 may be blocked by a lid member 41. In the lid member 41, a hole 41a is provided through which the shaft 18a is threaded. By this method as well, the leakage of the foodstuff F0 toward the outside from the pusher port 22 can be suppressed.

In the above described example, the case has been described where the horizontal cross-sectional shape of the hollow insides of the input port 21, the pusher port 22, the inner cylinder 28 and the blade part 29 and the horizontal cross-sectional shape of the discharge hole 34 are circular, but these horizontal cross-sectional shapes are not limited to the above description, and may be, for example, a polygonal shape such as a substantially quadrangular shape and a substantially pentagonal shape.

### Second Embodiment

In food forming system of the second embodiment, a plurality of forming devices are aligned in a width direction of the conveying belt, and thereby the number of formed food products is increased which are obtained per unit time. The details will be described below, but the other parts are similar to those of the first embodiment; and substantially the same components are denoted by the same reference numerals, and detailed description thereof will be omitted.

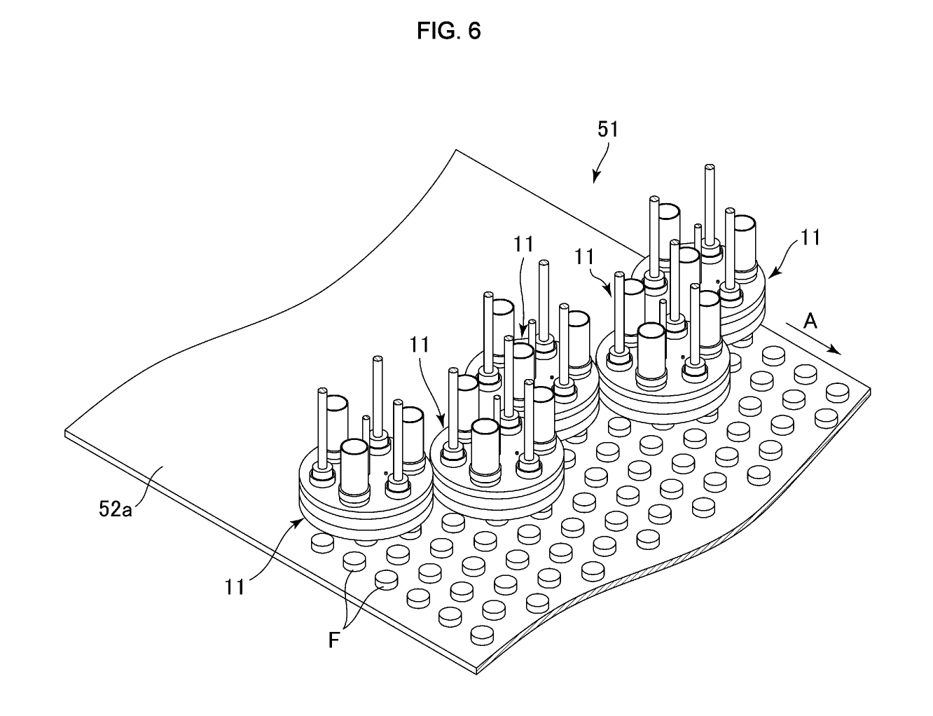

In the food forming system 51 of the second embodiment, a plurality of (five, in this example) forming devices 11 are aligned in the width direction (direction orthogonal to the conveying direction) of the conveying belt 52a, as shown in FIG. 6. A width of the conveying belt 52a which is used here is wider than that of the first embodiment so as to correspond to the plurality of forming devices 11. In this example, each of the forming devices 11 is controlled so that the operation timings are synchronized with each other, and the formed food products F are discharged and the mold plates are rotated at the same timing as each other. The number of forming devices 11 is not limited to five, and may be two to four, or also six or more.

As for the forming device 11, as described above in detail, a mechanism for injecting the foodstuff and discharging the formed food product F, and a mechanism for rotating the mold plate are provided on the upper side of the forming device 11. Because of this, the forming devices 11 do not interfere with the conveying belt 52a, and the forming devices 11 do not interfere with each other, and the arrangement as shown in the figure can be easily achieved. In addition, by a plurality of, in this example, five forming devices 11, fifteen articles F can be simultaneously discharged, but the mold plate is provided in each of the forming devices 11, and the mold plates are rotated by the motors, respectively. For example, in the case where a large number of formed food products F are discharged simultaneously from one frame member as in Patent Literature 1, the length of the frame member becomes long; thereby friction between the frame member and the bottom plate increases, and further, in order to suppress the leakage of the foodstuff from a gap between the frame member and the bottom plate, because of the deflection of the frame member, a pressing force for pressing the frame member to the bottom plate increases as the length of the frame member becomes long; and accordingly a considerable large force becomes necessary for sliding the frame member. However, in the configuration of the present embodiment as described above, even though the number of the formed food products increases which are discharged at the same time, the mold plate 15 is rotated by the motor in each of the forming devices 11, and accordingly the load on the motor does not increase.

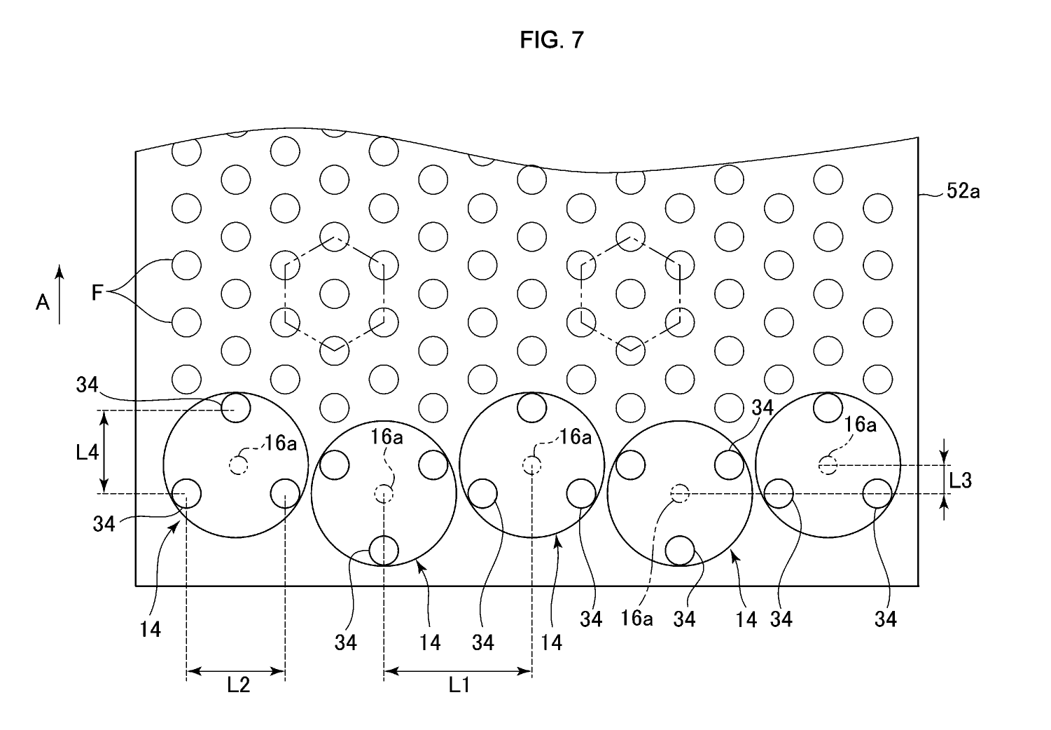

One example of the layout of the forming devices 11 of the above described food forming system 51 is shown in FIG. 7. In this layout example, the main body parts 14 of the respective forming devices 11 are aligned so that one side (hereinafter referred to as a reference side) of an equilateral triangle which has three discharge holes 34 as vertices becomes orthogonal to the moving direction of the conveying belt 52a. The directions of the equilateral triangles in the respective main body parts 14 are set so that adjacent triangles point opposite directions to each other. The distance L1 between centers of the main body parts 14 (mold plates 15) in the width direction is set so as to be 1.5 times of the length L2 of the reference side. In addition, as for the conveying direction, the positions of the main body parts 14 are deviated so that the distance L3 between the centers of the adjacent main body parts 14 becomes ⅓ times of the height L4 of the equilateral triangle, respectively, of which the reference side is set so as to be the bottom side. The respective main body parts 14 may be provided so that the directions of the equilateral triangles become the same as those of others.

When each of the forming devices 11 is laid out as described above, each of the forming devices 11 is operated so that the formed food products F are simultaneously discharged from each of the forming devices 11 every time the conveying belt 52a moves by a length of ⅔ of the height of a triangle of which the reference side is the bottom side. By doing so, the formed food products F discharged from each of the forming devices 11 show such a state that not only the formed food products F which are discharged from each of the forming devices 11 are arranged in the same pattern as that in the first embodiment, but also in the formed food products F which are discharged from a pair of adjacent forming devices 11, each of the formed food products F is arranged so as to become any one of each vertex of a regular hexagon of which one side has a length of ⅔ of the height of the equilateral triangle whose vertices are defined by the three discharge holes 34, and its center of gravity, as shown by the two-dot chain line in FIG. 7. Accordingly, the food forming system can maximize the number of the formed food products F per unit area while making the adjacent formed food products F equidistant.

The operation timings and layouts of the respective forming devices 11 in the above embodiment are one example, and are not limited to those described above. For example, it is also acceptable to arrange each of the forming devices 11 so as to be displaced from the above described arrangement in the conveying direction and control the operation timings of the forming devices 11 according to the arrangement of the forming devices 11, respectively, and thereby to discharge the formed food product F from each of the forming devices 11, in a state in which each of the formed food product F is arranged on the conveying belt 52 so as to become any one of each vertex of a regular hexagon of which one side has a length of ⅔ of the height of the equilateral triangle whose vertices are defined by the three discharge holes 34, and its center of gravity, as described above. In this case, each of the forming devices 11 operates the pusher 17 so as to discharge the formed food product F every time the conveying belt 52a moves by a length of ⅔ of the height of a triangle of which the reference side is the bottom side.

### Third Embodiment

In the third embodiment, a leakage prevention member is provided in the pusher port, which obstructs a gap between the outer peripheral surface of the pusher and a circumferential surface that forms the pusher port, and thereby suppresses the leakage of the foodstuff toward the outside of the main body part through the pusher port. The details will be described below, but the other parts are similar to those of the first embodiment; and substantially the same components are denoted by the same reference numerals, and detailed description thereof will be omitted.

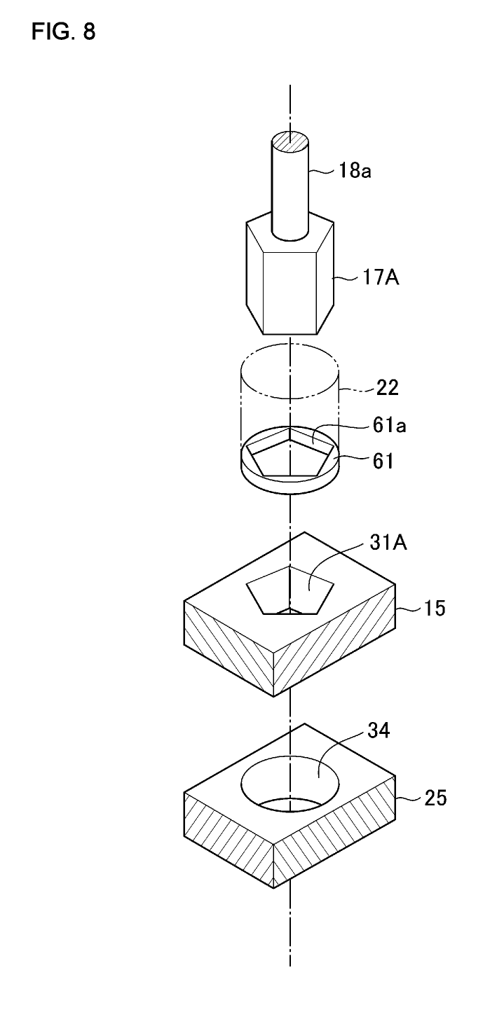

As shown in FIG. 8, in the forming device of this example, the horizontal cross-sectional shape of the forming hole 31A is a pentagon, which is formed in the mold plate 15, and the forming device is structured so as to be capable of obtaining a pentagonal formed food product, by using the pusher 17A which has, for example, the same horizontal cross-sectional shape and size as those of the forming hole 31A. A horizontal cross-sectional shape of the pusher port 22 is circular. At the lower end portion of the pusher port 22, a leakage prevention member 61 is provided which obstructs a gap between the outer peripheral surface of the pusher 17A and the inner circumferential surface of a sleeve which forms the pusher port 22. The leakage prevention member 61 has such a ring shape that an opening 61a is formed in the center portion thereof. The horizontal cross-sectional shape and size of the opening 61a are the same as those of the pusher 17A. The horizontal cross-sectional sizes of the pusher 17A and the forming hole 31A are smaller than the horizontal cross-sectional size of the pusher port 22.

The above described leakage prevention member 61 is fitted into the inside of the pusher port 22, for example, from the underside of the pusher port 22, and thereby is assembled to the inside of the lower end of the pusher port 22. The leakage prevention member 61 is assembled so that its lower surface is flush with the lower surface of the upper plate. For example, one or a plurality of positioning protrusions (not shown) are provided on the outer circumferential surface of the leakage prevention member 61, and a positioning groove (not shown) into which the positioning protrusions are fitted is formed on the lower surface of the upper plate. By the positioning protrusions being fitted into the positioning grooves, the leakage prevention member 61 is positioned in the pusher port 22 so that the direction of the opening 61a matches the forming hole 31A which is connected with the discharge hole 34. The leakage prevention member 61 is fixed, for example, is screwed, so as not to fall off from the inside of the pusher port 22. The leakage prevention member 61 which is attached to the pusher port 22 has a horizontal cross-sectional shape corresponding to the forming hole 31A.

According to the above described configuration, the pusher 17A moves to the extruding position through the opening 61a of the leakage prevention member 61, in other words, enters into the forming hole 31A, and pushes out the foodstuff F0 from the forming hole 31A. At this time, a state at the lower end of the pusher port 22 becomes such a state that the leakage prevention member 61 is arranged between the outer peripheral surface of the pusher 17A and the inner circumferential surface of the pusher port 22. Because of this, even if the foodstuff F0 has leaked out from the gap between the outer circumferential surface of the pusher 17A and the inner circumferential surface of the forming hole 31A, the foodstuff F0 is controlled so as not to enter into the pusher port 22 by the leakage prevention member 61. As a result, the foodstuff F0 is controlled so as not to leak out to the outside of the main body part 14 through the pusher port 22. The above configuration is particularly effective when the binding of the foodstuff F0 is weak.

The leakage prevention member 61 may be provided at least at the lower end portion of the pusher port 22 as described above, but may be provided, for example, over the lower end portion to the upper end portion of the pusher port 22.

In each of the above described embodiments, the case has been described where n=3, in other words, the number of the discharge holes, the first forming holes 31a and the second forming holes 31b are three each, but the number of the discharge holes, the first forming holes 31a and the second forming holes 31b may be two (n=2) or more. In addition, the upper plate 27 may not be provided.

### Fourth Embodiment

A fourth embodiment has a configuration in which a fitting member for connecting the pipe with the input port and a lid member for closing the upper end of the pusher port are connected by a cover member that is arranged above the upper plate. The details will be described below, but the other parts are similar to those of the first embodiment; and substantially the same components are denoted by the same reference numerals, and detailed description thereof will be omitted.

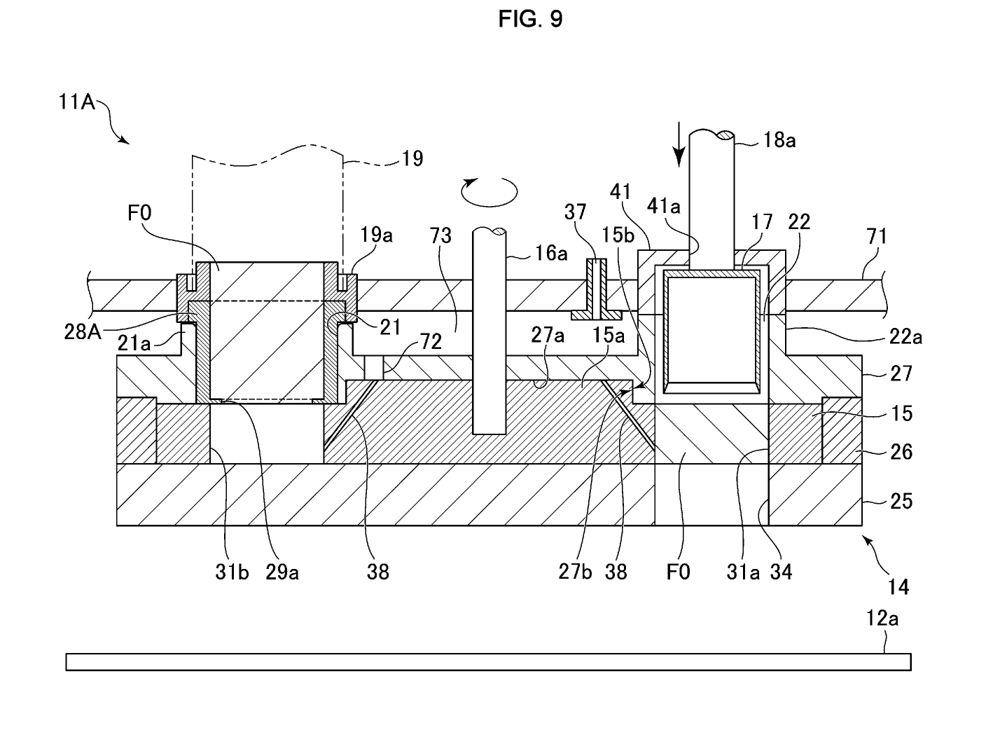

In FIG. 9, in a forming device 11A in this example, the main body part 14 includes the mold plate 15, the bottom plate 25, the spacer 26, the upper plate 27, a cover member 71 and an inner cylinder 28A, and the upper plate 27 and the cover member 71 are arranged on the mold plate 15 in order. To the cover member 71, the fitting member 19a and the lid member 41 are fixed. The rotating shaft 16a is passed through each hole provided in the cover member 71 and the upper plate 27, and one end thereof is engaged with the mold plate 15. In FIG. 9, the mold plate 15 is positioned at the first rotation position at which the first forming hole 31a is connected with the discharge hole 34.

The upper plate 27 and the cover member 71 are each movable in a vertical direction, and are moved in the upward direction at the time of cleaning or the replacement of the mold plate 15. The fitting member 19a and the lid member 41 move in the vertical direction integrally with the cover member 71. By the movement in the vertical direction of the cover member 71, attachment and detachment of the pipe 19 to and from the input port 21 and closing and opening of the upper part of the pusher port 22 can be performed at the same time. The upper plate 27 and the cover member 71 are each supported so that the upper plate 27 and the cover member 71 do not rotate together with the rotation of the mold plate 15. In this example, in the inside of the input port 21, the inner cylinder 28A is arranged in which the cutting blade 29a is integrally formed at the lower end.

In the vicinity of each of the input ports 21 of the upper plate 27, a through hole 72 is formed which penetrates in the thickness direction (vertical direction). The lower end of each of the through holes 72 is connected to one end of an air vent hole 38 that is linked to the forming hole 31 which is connected with the input port 21, when the mold plate 15 exists in the first or second rotation position. As shown in the figure, in the use state, an airtight space 73 which is surrounded by the upper plate 27 and the cover member 71 and the like is formed above the center portion of the upper plate 27, and each of the through holes 72 communicates with one pressure-reducing hole 37 which is provided in the cover member 71, via the airtight space 73. Thereby, air in the forming holes 31 can be removed from the one pressure-reducing hole 37 through the respective air vent holes 38.

The forming device 11A configured as described above also rotates the mold plate 15 to the first rotation position and the second rotation position, similarly to the forming device in the first embodiment; and discharges the formed food products and injects the foodstuff at the rotation positions, respectively. Thereby, more formed food products can be obtained per unit time.

### REFERENCE SIGNS LIST

10 and 51 Food forming system
11 and 11A Food forming device
12a and 52a Conveying belt
15 Mold plate
17 Pusher
25 Bottom plate
27 Upper plate
28 and 28A Inner cylinder
31 Forming hole
34 Discharge hole
61 Leakage prevention member
71 Cover member
F0 Foodstuff
F Formed food product

1. A food forming device comprising:
a bottom plate including n discharge holes provided in a circumferential direction, n being an integer of two or more;
a mold plate that is rotatable on the bottom plate and includes n first forming holes and n second forming holes provided alternately in a circumferential direction of the mold plate, the mold plate being configured to intermittently rotate to a first rotation position and to a second rotation position, wherein:
in the first rotation position, the first forming holes are respectively connected with the discharge holes while lower openings of the second forming holes are obstructed by the bottom plate; and
in the second rotation position, the second forming holes are respectively connected with the discharge holes while lower openings of the first forming holes are obstructed by the bottom plate;
a plurality of filling openings that is:
deviated from the discharge holes in the circumferential direction;
respectively configured to be connected to upper openings of the second forming holes when the mold plate is in the first rotation position;
respectively configured to be connected to upper openings of the first forming holes when the mold plate is in the second rotation position; and
configured to inject foodstuffs into the first forming holes or the second foil ling holes connected to the plurality of filling openings; and
a plurality of pushers that is vertically movable and is respectively provided above the discharge holes, and configured to push out the foodstuffs from the first forming holes or the second forming holes to discharge the foodstuffs as formed food products from the discharge holes every time the mold plate intermittently rotates.

2. The food forming device according to claim 1, wherein the plurality of pushers is configured to push out the foodstuffs from the first forming holes or the second forming holes during injection of the foodstuffs from the plurality of filling openings.

3. The food forming device according to claim 1, wherein
the discharge holes are three discharge holes,
the first forming holes are three first forming holes,
the second forming holes are three second forming holes, and
the three discharge holes are provided at intervals of 120°.

4. The food forming device according to claim 1, wherein
the mold plate includes an air vent hole for each of the first forming holes and the second forming holes, the air vent hole being configured to communicate with each first forming hole or with each second forming hole to remove air from inside to outside.

5. The food forming device according to claim 1, further comprising cutting blades respectively provided in the plurality of filling openings to cut the foodstuffs.

6. The food forming device according to claim 1, further comprising an upper plate arranged on the mold plate, the upper plate including:
input ports respectively having lower parts in which the plurality of filling openings is respectively provided; and
pusher ports which respectively accommodate the plurality of pushers.

7. The forming device according to claim 6, wherein
the upper plate has a circumferential first step, and
the mold plate has a circumferential second step which is engaged with the circumferential first step, and
the mold plate is configured to rotate with the circumferential first step and the circumferential second step engaged with each other.

8. The food forming device according to claim 6, further comprising a spacer arranged on an outer circumference of the mold plate to surround the mold plate.

9. The food forming device according to claim 6, further comprising lid members for respectively obstructing upper openings of the plurality of pusher ports.

10. A food forming system comprising:
the food forming device according to claim 1; and
a conveying belt which is arranged below the bottom plate, and is configured to intermittently or continuously move the formed food products.

11. The food forming system according to claim 10, comprising a plurality of food forming devices aligned in a width direction of the conveying belt, each of the plurality of food forming devices being defined as the food forming device.

12. The food forming system according to claim 11, wherein
the discharge holes are three discharge holes provided at intervals of 120°,
the first forming holes are three first forming holes,
the second forming holes are three second forming holes,
the three first forming holes and the three second forming holes are provided alternately at intervals of 60°,
the plurality of food forming devices is provided so that any one of sides of an equilateral triangle whose vertices are defined by the three discharge holes is orthogonal to a moving direction of the conveying belt, and
the plurality of pushers is configured to push out the foodstuffs from the three first forming holes or the three second forming holes every time the conveying belt moves by a length of ⅔ of a height of the equilateral triangle.

13. A food forming device comprising:
a mold plate that is rotatable and includes n first forming holes and n second forming holes provided in a circumferential direction of the mold plate, n being an integer of two or more, the mold plate being configured to intermittently rotate to a first rotation position and to a second rotation position, wherein:
in the first rotation position, first formed food products are discharged from lower openings of the first forming holes while lower openings of the second forming holes are obstructed; and
in the second rotation position, second formed food products are discharged from the lower openings of the second forming holes while the lower openings of the first forming holes are obstructed;
a plurality of filling openings that is:
respectively configured to be connected to upper openings of the second forming holes when the mold plate is in the first rotation position;
respectively configured to be connected to upper openings of the first forming holes when the mold plate is in the second rotation position; and
configured to inject foodstuffs into the first forming holes or the second forming holes connected to the plurality of filling openings; and
a plurality of pushers that is vertically movable and configured to push out the foodstuffs from the first forming holes or the second forming holes to discharge the foodstuffs as the first formed food products or the second formed food products every time the mold plate intermittently rotates.

14. A food manufacturing method comprising:
intermittently rotating a mold plate to a first rotation position and to a second rotation position, the mold plate including n first forming holes and n second forming holes provided in a circumferential direction of the mold plate, n being an integer of two or more, wherein:
in the first rotation position, first formed food products are discharged from lower openings of the first forming holes while lower openings of the second forming holes are obstructed; and
in the second rotation position, second formed food products are discharged from the lower openings of the second forming holes while the lower openings of the first forming holes are obstructed;
injecting foodstuffs into the first forming holes or the second forming holes from upper openings of the second forming holes when the mold plate is in the first rotation position and from upper openings of the first forming holes when the mold plate is in the second rotation position; and
every time the mold plate intermittently rotates, pushing out the foodstuffs from the first forming holes to discharge the foodstuffs as the first formed food products when the mold plate is in the first rotation position and from the second forming holes to discharge the foodstuffs as the second formed food products when the mold plate is in the second rotation position.
